(19) United States
(12) Patent Application Publication
(10) Pub. No.: US 2011/0056139 A1
(43) Pub. Date: Mar. 10, 2011

(54) OUTWARDLY OPENING FOR A WINDOW OR DOOR ASSEMBLE

(75) Inventor: Niels Peter Christensen, Ringkobing (DK)

(73) Assignee: VKR HOLDING A/S, Horsholm (DK)

(21) Appl. No.: 12/736,264

(22) PCT Filed: Aug. 21, 2008
(86) PCT No.: PCT/EP2008/060960

§ 371 Date: Nov. 12, 2010

(30) Foreign Application Priority Data
Mar. 26, 2008 (EP) 08153351.5

(51) Int. Cl. E05C 9/18; E06B 3/36; E05B 65/06; E05B 3/00

(52) U.S. Cl. 49/395; 49/394

(57) ABSTRACT

The outwardly opening window or door assembly (1) comprises a sash (3) mounted in a frame (2). A locking device (7) comprises a housing (101) being mounted in a cavity of a sash member. A handle (102) is adapted to displace a locking element (8, 9) between a locked position and an unlocked position. The handle (102) protrudes through an actuation opening (114) in a face (136) of the sash member being substantially at right angles to the window pane (4) or door leaf. The handle (102) is provided with an at least partially circular engagement portion (133) extending through the actuation opening (144) in the face of the sash member, and the at least partially circular engagement portion (133) is provided with a wedge shaped recess (110) that is releasably engaged with a correspondingly shaped wedge shaped element (III) pivotably arranged in the housing (101).

The present invention relates to an outwardly opening window or door assembly comprising a sash carrying a window pane or door leaf and being mounted in a frame movable between an open position and a closed position, a locking device comprising a housing being mounted in a cavity of a sash member of the sash, the locking device comprising at least one displaceable locking element adapted to engage a striking plate mounted on the frame and a handle adapted to displace the locking element between a locked position and an unlocked position, the handle protruding through an actuation opening in a face of the sash member, said face of the sash member being substantially at right angles to the window pane or door leaf.

In known outwardly opening window or door assemblies it may be difficult to replace the handle, as the entire housing of the locking device must be removed from the sash in order to disassemble the handle from the locking device. Furthermore, restrictions exist to the design of the handle, because the handle must be of such a form that it can pass through the actuation opening in the face of the sash member in order to be removed with the locking device.

The object of the present invention is to provide an outwardly opening window or door assembly, wherein the handle is easier to replace.

In view of this object, the outwardly opening window or door assembly is characterized in that the handle is provided with an at least partially circular engagement portion extending through the actuation opening in the face of the sash member, and in that the at least partially circular engagement portion is provided with a wedge shaped recess that is releasably engaged with a correspondingly shaped wedge shaped element pivotably arranged in the housing.

Thereby, the handle may be easily removed from the locking device by releasing the engagement between the at least partially circular engagement portion and the wedge shaped element. The at least partially circular engagement portion may be lifted out through the actuation opening, without the handle needing to pass through the opening.

In an embodiment, the wedge shaped element is pivotably arranged about an axis located near said face of the sash member being substantially at right angles to the window pane or door leaf. Thereby, a relatively close fit between the at least partially circular engagement portion and the actuation opening is possible, still allowing the at least partially circular engagement portion to be removed through the actuation opening. A close fit is esthetically preferable and avoids problems with dirt entering the locking device.

In an embodiment, the at least partially circular engagement portion is releasably engaged with the wedge shaped element by means of a pin extending tangentially in the at least partially circular engagement portion. Thereby, the handle may be removed without access to the locking device.

In an embodiment, the pin is accessible from outside the sash member, when the handle is in the unlocked position. Thereby, the pin is invisible in the locked position of the handle.

In an embodiment, the housing comprises two opposed side walls that extend through the actuation opening in the face of the sash member and cover the at least partially circular engagement portion of the handle, and the wedge shaped element is pivotably mounted in the two opposed side walls that extend through the actuation opening. Thereby, the engagement between the at least partially circular engagement portion wedge shaped element is invisible and protected from dirt, although the axis of the wedge shaped element is located at the outside of the sash member.

In an embodiment, the wedge shaped element is pivotably connected to a link arm that is pivotably connected to a first displaceable element that is arranged displaceably in the housing in the longitudinal direction of the sash member and carries a first locking element, and in that the pivot point between the wedge shaped element and the link arm, in the locked position of the handle, is arranged on the opposite side of the line that connects the pivot point between the wedge shaped element and the housing and the pivot point between the link arm and the first displaceable element when compared to the position of the pivot point between the wedge shaped element and the link arm in the unlocked position of the handle. Thereby, in the locked position, an unauthorized attempt to open the window or door by displacing the first locking element will result in the handle being rotated even more in the closing direction, which may be prevented by a stopper.

In an embodiment, a second displaceable element is arranged displaceably in the housing in the longitudinal direction of the sash member and carries a second locking element, and a gear in the form of a pivotable element with two arms protruding from a centre pivot is arranged such that a first of the two arms is placed in a recess in the first displaceable element and a second of the two arms is placed in a recess in the second displaceable element. Thereby, the first and the second locking elements will be displaced in opposite directions in order to engage their respective striking plates when locking the window or door, thereby preventing attempts to open the window or door by displacing the sash in the direction of the sash member comprising the locking device.

In an embodiment, the second of the two arms is longer than the first of the two arms. This may counteract the effect of backlash in the gear connecting the first and second locking elements, so that it is obtained that both locking elements travels the same distance during the locking operation.

In an embodiment, the first and the second displaceable elements are provided with locking elements in the form of a first and a second mushroom cam, respectively, for engagement with a centre striking plate mounted on a frame member extending along the sash member comprising the locking device. Thereby, the tamper proof effect of the opposite travel direction of the first and the second locking elements may be enhanced, as the first and a second mushroom cams may engage opposed recesses in a single striking plate. When trying to force one mushroom cam away from the centre striking plate, the other mushroom cam will be pressed more in to the centre striking plate.

In an embodiment, the first and the second displaceable elements are provided with locking elements in the form of first and second espagnolette bolts, respectively, extending along an outer edge of the sash member that comprises the locking device and being arranged for engagement with corner striking plates mounted at corners of the frame.

In an embodiment, the first and second espagnolette bolts have a rectangular shape with one dimension being larger than the other dimension, so that the larger dimension is arranged perpendicular to a general plane of the window pane or door leaf. In this way, the bolts do not protrude out from the sash very much. Furthermore, since the large dimension of the cross section of the bolts is arranged perpendicular to the general plane of the window or door assembly, the strength of the bolt in the direction which would be exposed to large forces during an attempted break-in will be very large.

In an embodiment, each of the first and second espagnolette bolts has an engagement portion adapted to engage a respective corner striking plate, wherein the engagement portion is split up into two separate end bolts spaced in a direction perpendicular to the general plane of the window pane or door leaf. Thereby, a ventilation position of the window or door is provided when only one of the separate end bolts is engaged with the corner striking plate.

In an embodiment, a centre striking plate comprises a first flange and a second flange which are arranged at an angle to each other, the second flange is mounted to an outwardly facing surface of a frame member extending along the sash member comprising the locking device, and the first flange comprises L-shaped recesses for engagement with the mushroom cams of the locking device. Due to the arrangement of the striking plate, in the case where the window or door assembly is attempted to be forced open, the striking plate will bend such that it is even more locked.

In an embodiment, first and second corner striking plates are arranged at the corners of the frame corresponding to the first and second espagnolette bolts, respectively, and each corner striking plate comprises a first flange having a recess for engagement with the respective espagnolette bolt and a second flange being mounted to an outwardly facing surface of both frame members at the respective corner. As the corner striking plate is attached to both frame members at the corner, the strength of the joint is increased, and the forces applied to the striking plate are allowed to be split between the two frame members. The striking plate is also arranged such that if force is applied during a break in attempt, the striking plate will bend about a line connecting the mounting screws across the corner, and the striking plate will bend into an even more locked position.

The present application further discloses a separate invention relating to a locking device for a window or door assembly, the locking device comprising a housing adapted to be mounted in a cavity of a sash member of the sash, the locking device comprising at least one displaceable locking element adapted to engage a striking plate mounted on the frame and a handle adapted to displace the locking element between a locked position and an unlocked position, the handle being adapted to rotate a rotating element arranged in the housing and being pivotably connected to a link arm that is pivotably connected to a first displaceable element that is arranged displaceably in the housing in the longitudinal direction of the sash member and carries a first locking element, and a longitudinal axis of the link arm, in the locked position of the handle, being arranged on the opposite side of the line that connects the pivot point between the rotating element and the housing and the pivot point between the link arm and the first displaceable element when compared to the position of the longitudinal axis of the link arm in the unlocked position of the handle.

The present application further discloses a separate invention relating to a locking device for a window or door assembly, the locking device comprising a housing adapted to be mounted in a cavity of a sash member of the sash, the locking device comprising first and second displaceable locking elements adapted to engage a striking plate mounted on the frame and a handle adapted to displace the locking elements between a locked position and an unlocked position, a gear in the form of a pivotable element with two arms protruding from a centre pivot is arranged such that a first of the two arms is placed in a recess in the first displaceable element and a second of the two arms is placed in a recess in the second displaceable element, and, preferably, the second of the two arms is longer than the first of the two arms. The displaceable elements may be provided with locking elements in the form of mushroom cams and/or espagnolette bolts.

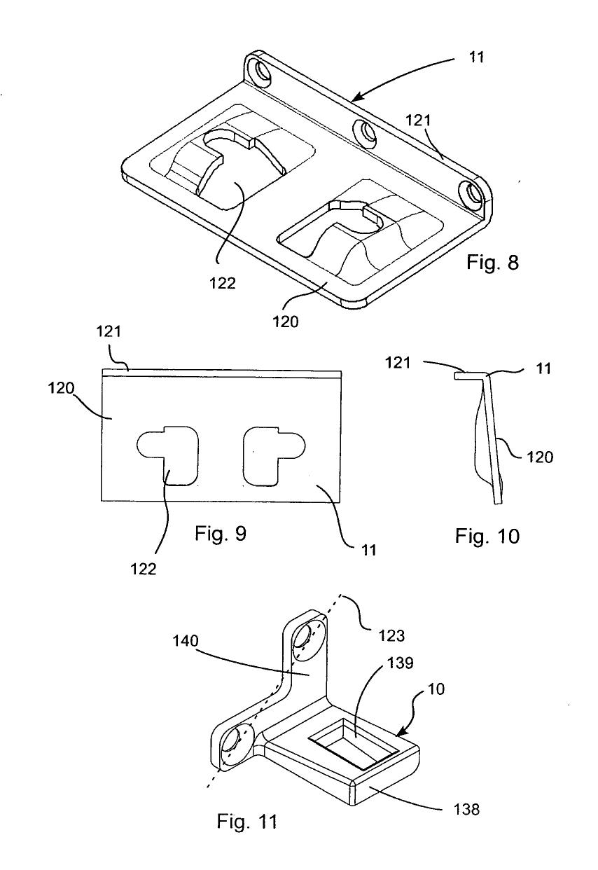

The present application further discloses a separate invention relating to a centre striking plate comprising a first flange and a second flange which are arranged at an angle to each other, the second flange being adapted to be mounted to an outwardly facing surface of a frame member extending along a sash member comprising a locking device, and the first flange comprising L-shaped recesses for engagement with mushroom cams of the locking device, the centre striking plate preferably having a design substantially as shown in FIGS. 8 to 10 or in FIG. 25.

The present application further discloses a separate invention relating to a corner striking plate adapted to be arranged at a corner of a frame, the corner striking plate comprising a first flange having a recess for engagement with an espagnolette bolt and a second flange being adapted to be mounted by means of screws to an outwardly facing surface of both frame members at the corner, the corner striking plate preferably having a design substantially as shown in FIG. 11 or in FIGS. 21 and 22.

The inventions will now be explained in more detail below by means of examples of embodiments with reference to the very schematic drawing, in which

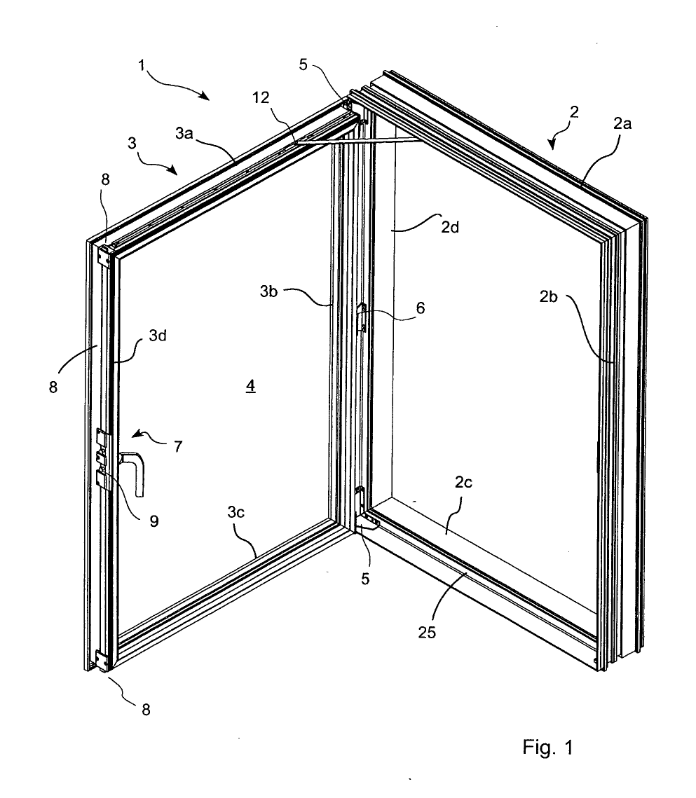

FIG. 1 shows a perspective view of an embodiment of a complete outwardly opening side hinged window or door assembly according to the current invention.

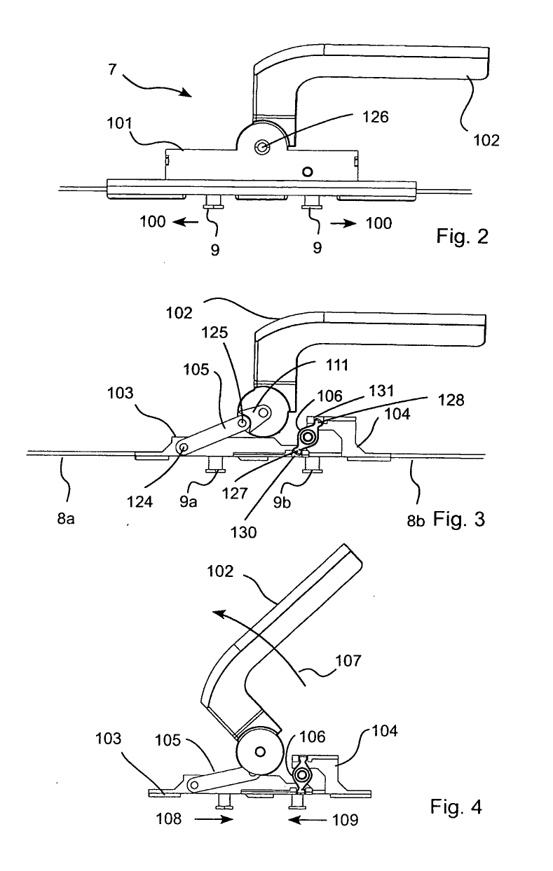

FIG. 2 shows a detailed side view of the locking device shown in FIG. 1 in the locked position.

FIG. 3 shows a detailed side view of the locking device shown in FIG. 2 but without the housing so that the inner workings of the locking device can be seen.

FIG. 4 shows a detailed side view of the locking device shown in FIG. 3 but in the open position.

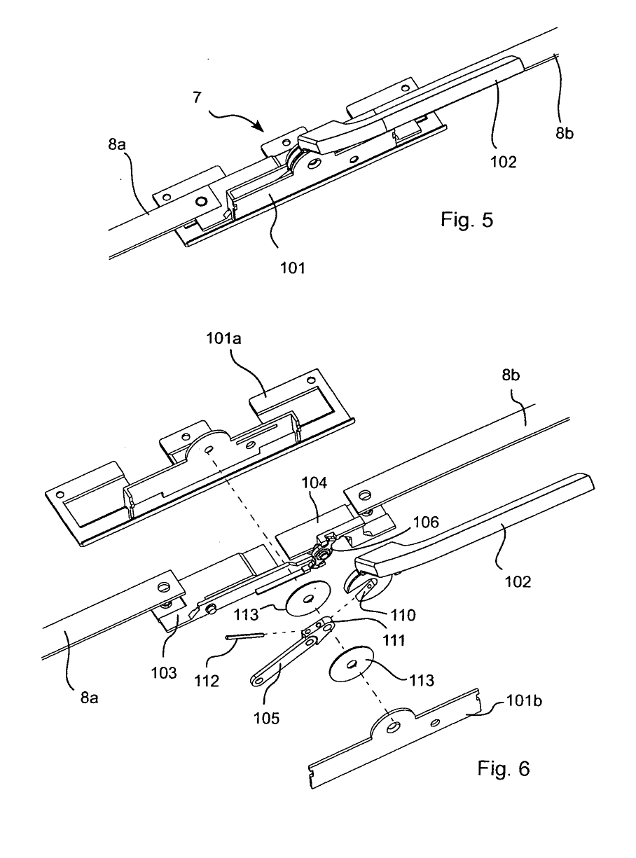

FIG. 5 shows a perspective detailed view of the locking device shown in FIG. 2.

FIG. 6 shows an exploded perspective view of the locking device shown in FIG. 2.

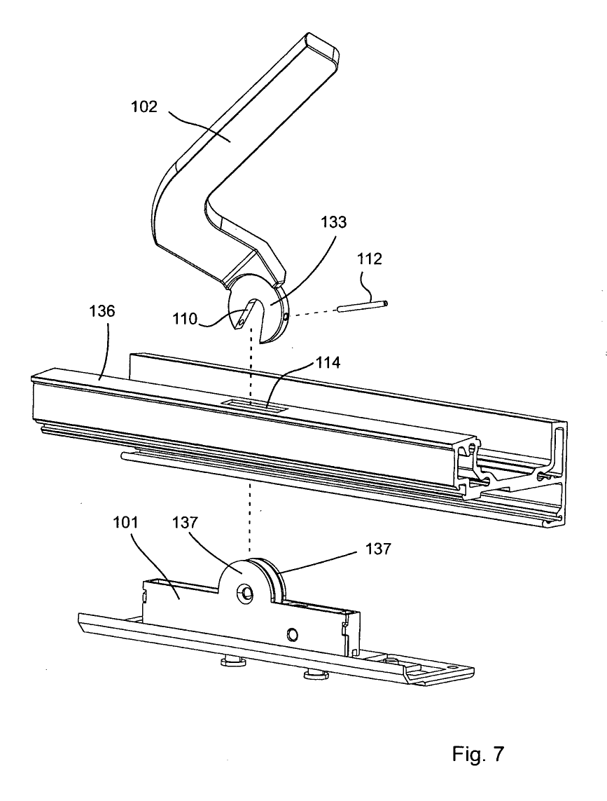

FIG. 7 shows an exploded perspective view of the procedure used to mount the locking device in a sash member.

FIGS. 8 to 10 show respectively a perspective view, a top view and a side view of a locking plate to which the locking device of FIG. 2 locks when the window or door assembly of FIG. 1 is closed.

FIG. 11 shows a perspective view of a corner locking plate to which the bolts of the locking device lock when the window or door assembly of FIG. 1 is closed.

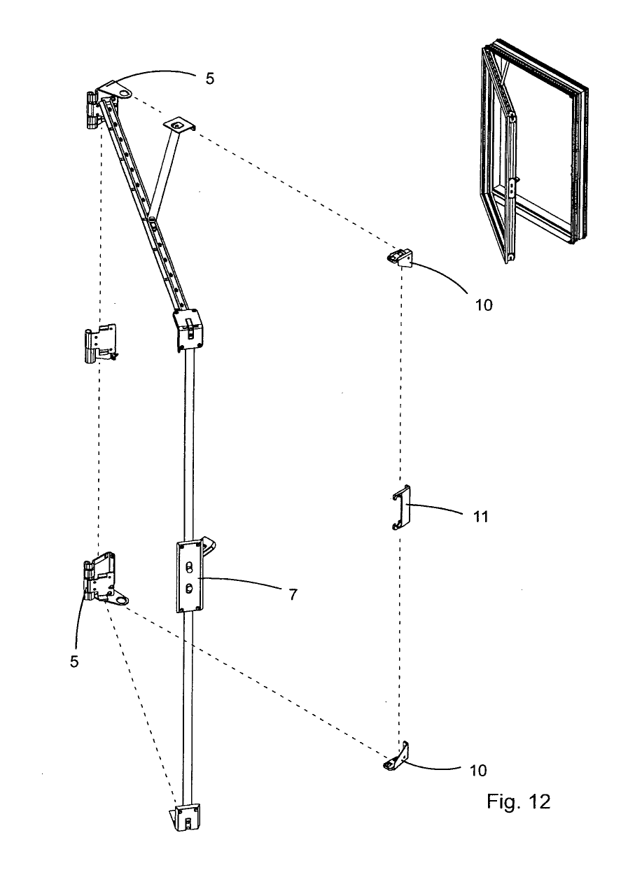

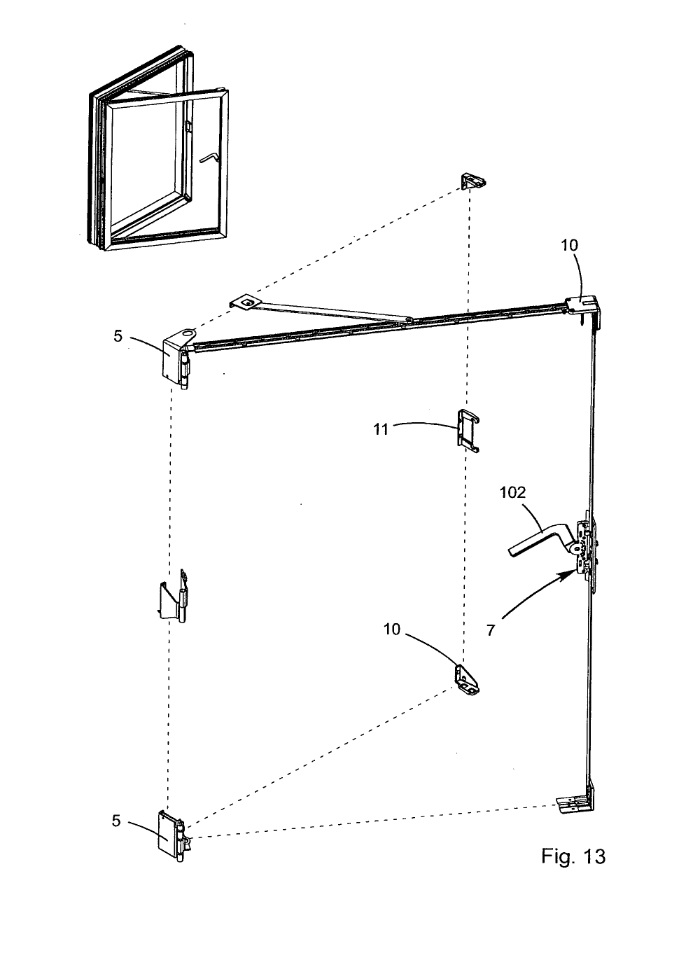

FIGS. 12 and 13 show perspective illustrations of a window or door assembly according to the current invention, whereby a small-scale figure indicates the complete window or door assembly, and a large-scale figure shows the fittings only, and whereby the locking device is in the unlocked position.

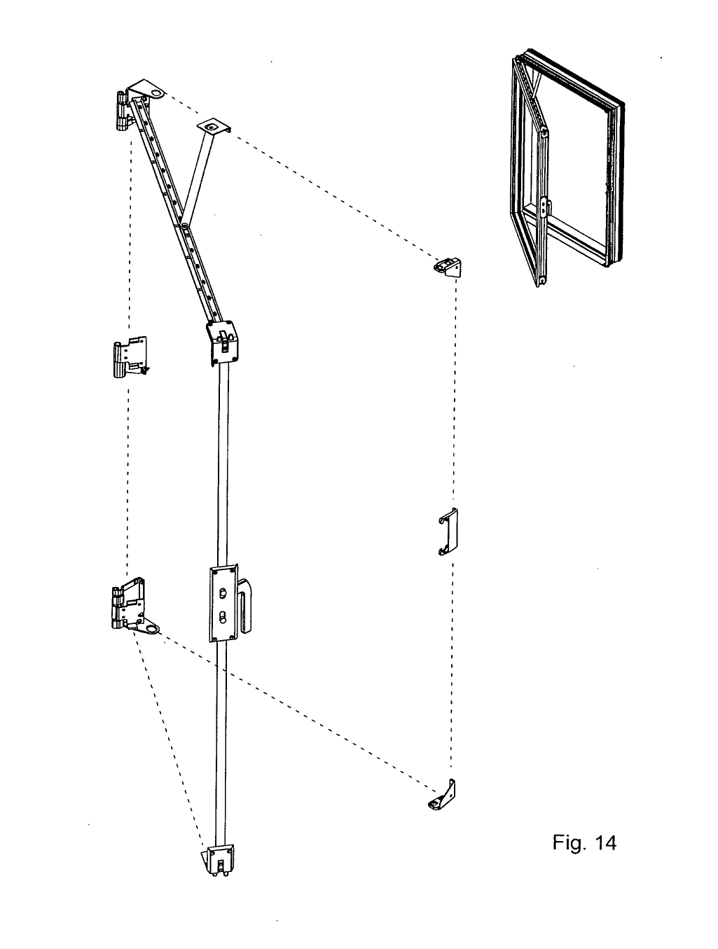

FIGS. 14 and 15 show perspective illustrations of a window or door assembly according to the current invention, whereby a small-scale figure indicates the complete window or door assembly, and a large-scale figure shows the fittings only, and whereby the locking device is in the locked position.

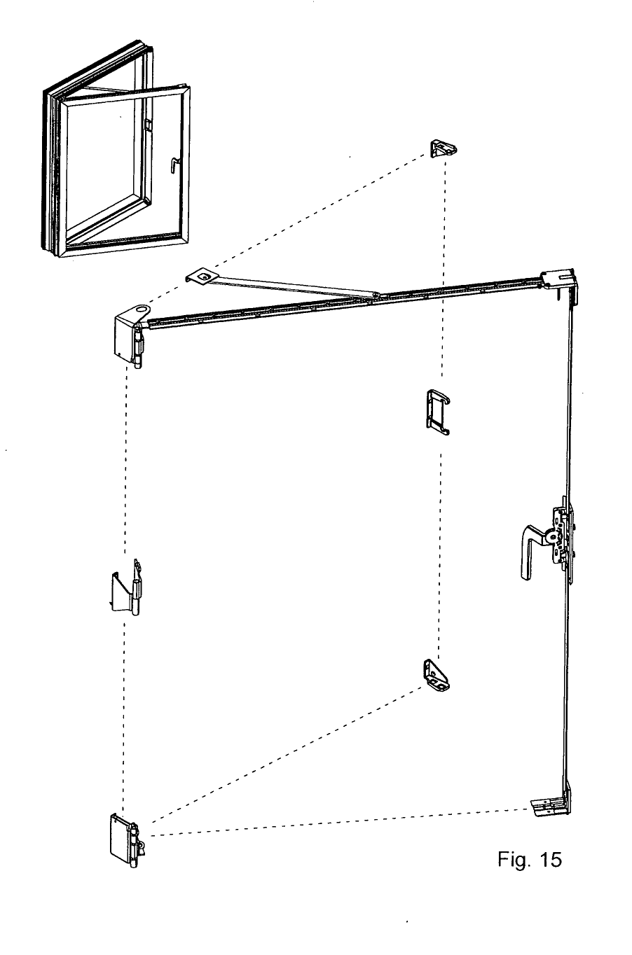

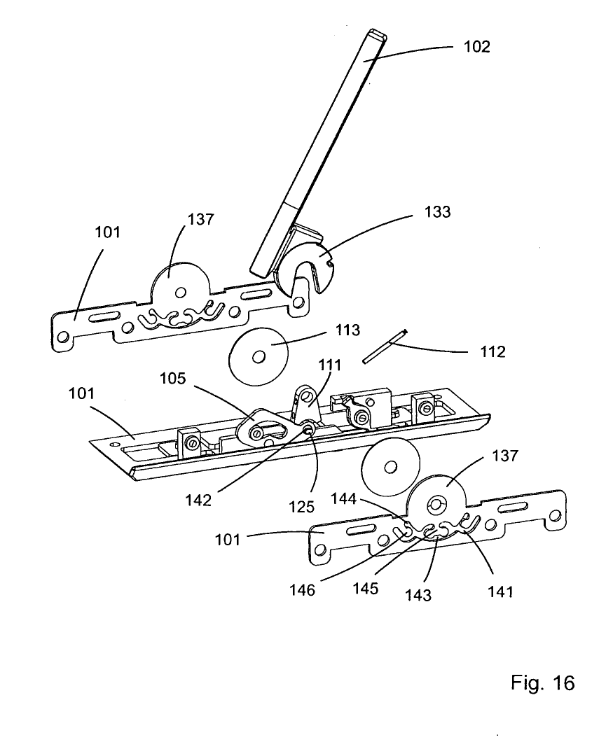

FIG. 16 shows an exploded perspective view of the locking device shown in FIGS. 12 to 15.

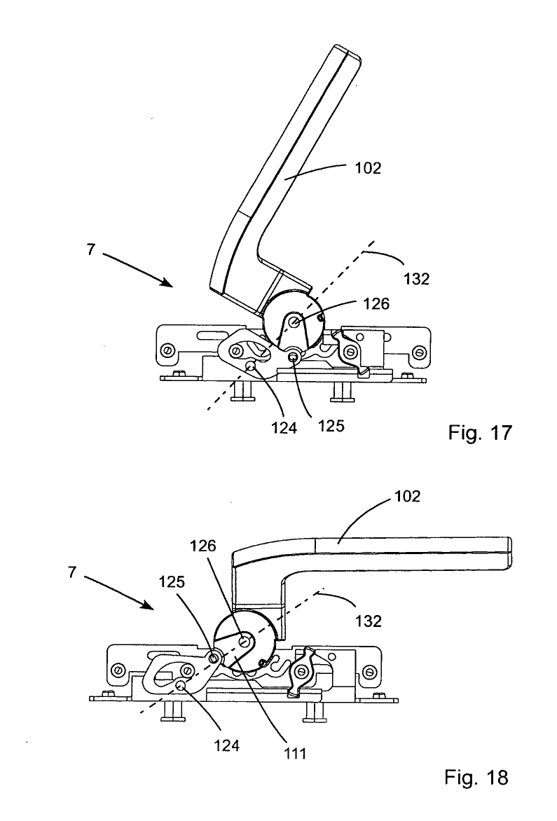

FIG. 17 shows a detailed side view of the locking device shown in FIG. 16, in the unlocked position, but without the front part of the housing so that the inner workings of the locking device can be seen.

FIG. 18 shows a detailed side view of the locking device shown in FIG. 17 but in the locked position.

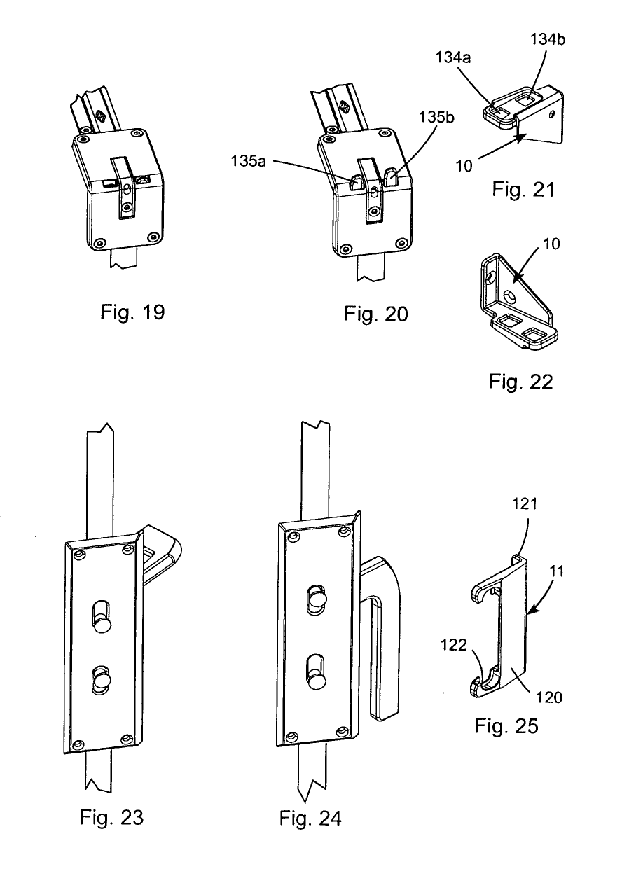

FIG. 19 shows a perspective view of the upper espagnolette bolt in the unlocked position shown in FIG. 12.

FIG. 20 shows a perspective view of the upper espagnolette bolt in the locked position shown in FIG. 14.

FIG. 21 shows a perspective view of the upper corner striking plate shown in FIG. 14.

FIG. 22 shows a perspective view of the lower corner striking plate shown in FIG. 13.

FIG. 23 shows a detailed perspective view of the locking device in the unlocked position shown in FIG. 12.

FIG. 24 shows a detailed perspective view of the locking device in the locked position shown in FIG. 14.

FIG. 25 shows a detailed perspective view of the centre striking plate shown in FIG. 14.

FIG. 1 shows an outwardly opening side hinged window assembly 1 according to the current invention. However, the invention is likewise applicable to a door assembly. The window or door assembly comprises a frame 2 made up of four frame elements or members 2a, 2b, 2c, 2d connected together with mitre joints, a sash 3 made up of four sash elements 3a, 3b, 3c, 3d connected together with mitre joints and a triple glazed pane of glass 4 arranged inside the sash 3. Two corner hinges 5 and a centre hinge 6 connect the sash 3 to the frame 2.

A locking device 7 forming part of an espagnolette mechanism is used to lock the sash in the closed position. FIGS. 2 to 7 show different views of an embodiment of the locking device 7. The locking device 7 is adapted to displace two espagnolette bolts 8 outwards in opposite directions such that they protrude from the outer edges of the sash. The locking device 7 also comprises two mushroom cams 9 which are also displaced outwards in opposite directions, as shown by the arrows 100 when the locking device is locked. The espagnolette bolts engage with corner striking plates 10, which are mounted at the corners of the frame, when the window or door assembly is closed and the locking device is in its locked position, and the mushroom cams engage with a centre striking plate 11 mounted at the centre of the frame when the window or door assembly is closed and the locking device is in its locked position. FIG. 1 shows the window assembly in its open position and the locking device in its locked position. FIGS. 14 and 15 show another embodiment of the window assembly in its open position and the locking device in its locked position. FIGS. 12 and 13 show this latter embodiment of the window assembly in its open position and the locking device in its unlocked position.

A window or door brake device 12 is mounted on the top sash element and is activated by the displacement of the upper espagnolette bolt 8 of the espagnolette mechanism. The window or door brake device 12 is arranged such that the window or door is held in the open position when the locking device 7 is in the locked position. When the locking device 7 is put into its unlocked position, the window or door brake device 12 allows the sash 3 to freely open and close.

As can be seen from FIG. 1, the espagnolette bolts 8 are arranged as rods having a rectangular cross section. As can be seen the longitudinal axes of the bolts are arranged along the outer edge of the sash element. In this particular embodiment, the bolts are arranged visibly on the outer edge of the sash element, but they could also be integrated inside the sash element in another embodiment. In the case where the bolts are visible, they could be made from the same material as the sash element. This will give a good visual impression.

The espagnolette bolts 8 are also arranged such that the cross section of the bolts has a rectangular shape with one dimension being larger than the other dimension, see FIGS. 5 and 6. The larger dimension is arranged perpendicular to the plane of the window or door assembly and the smaller dimension is arranged parallel to the plane of the window or door assembly. In this way, the espagnolette bolt does not protrude out from the sash very much. Furthermore, since the large dimension of the cross section of the bolt is arranged perpendicular to the plane of the window or door assembly, the strength of the bolt in the direction which would be exposed to large forces during an attempted break-in will be very large. It should be noted that the espagnolette bolts 8 are shown as a single element in the figures which are connected to the locking device and which engage with the corner striking plates on the frame when locked. However, it could also be imagined that each of the bolts were arranged as an elongated member and a bolt, where the bolt is arranged to engage with the striking plate and the elongated member is arranged to connect the bolt with the locking device. In this way, the bolt could be made from metal and the elongated member could for instance be made from a composite material.

As can be seen from FIGS. 2 to 7, the locking device 7 comprises a housing 101, a handle 102, a first displaceable element 103, a second displaceable element 104, a link arm 105 pivotably connected to the first displaceable element 103 at a pivot point 124 and pivotably connected at a pivot point 125 to a wedge shaped element 111 located in a wedge shaped recess 110 of the handle 102, and a pivotable element 106 for transferring the motion of the first displaceable element to the second displaceable element. The handle 102 is together with the wedge shaped element 111 pivotably arranged in the housing about a pivot point 126. As the handle pivots counter clockwise with respect to the figures as shown by the arrow 107 in FIG. 4, the link arm 105 is pulled to the right in the figures as shown by the arrow 108 in FIG. 4. The first displaceable element 103 is therefore displaced to the right. A gear in the form of the pivotable element 106 with two arms 127, 128 protruding from a centre pivot point 129 is arranged such that one 127 of the two arms is placed in a recess 130 in the first displaceable element 103. The second 128 of the two arms is placed in a recess 131 in the second displaceable element 104. As the first displaceable element 103 moves to the right, the pivotable element 106 rotates counter clockwise with regards to the figures. The second displaceable element 104 is therefore moved to the left as shown by the arrow 109 in FIG. 4.

It should be noted that the pivotable element 106 takes the place of a toothed gear wheel usually used in mechanisms of this type. The use of a pivotable element with two arms instead of a toothed gear wheel results in a number of advantages. A first advantage is that the mechanism cannot be assembled incorrectly. Another advantage is that the arms of the pivotable element can be made stronger than the teeth of a toothed gear wheel. Yet another advantage is that the second 128 of the two arms may be longer than the first 127 of the two arms. This may counteract the effect of backlash in the gear connecting the first and second displaceable elements 103, 104, so that it is obtained that both displaceable elements travels the same distance during the locking operation.

A first espagnolette bolt 8a and a first mushroom cam 9a are connected to the first displaceable element 103 and a second espagnolette bolt 8b and a second mushroom cam 9b are connected to the second displaceable element 104. As the displaceable elements are displaced, the respective espagnolette bolts and mushroom cams are also displaced.

FIGS. 16 to 18 show another embodiment of the locking device 7 according to the invention. In this embodiment, in the locked position of the locking device 7 as shown in FIG. 18, the pivot point 125 between the wedge shaped element 111 and the link arm 105, in the locked position of the handle 102, is arranged on the opposite side of the line 132 that connects the pivot point 126 between the wedge shaped element 111 and the housing 101 and the pivot point 124 between the link arm 105 and the first displaceable element 103 when compared to the position of the pivot point 125 between the wedge shaped element 111 and the link arm 105 in the unlocked position of the locking device 7 as shown in FIG. 17. In this way, the locking device is self locking whereby it is not possible to force the handle to rotate into an open position by pushing on the espagnolette bolts or the mushroom cams when the locking device is in the locked position. By forcing the espagnolette bolts or the mushroom cams in the locked position of the window or door, the handle will try to rotate to an even more locked position.

Furthermore, in the embodiment of the locking device 7 shown in FIGS. 16 to 18, a cut-out 141 has been provided in the housing 101 in order to provide suitable rest positions for the handle 102 in the locked and unlocked positions, respectively. The pivot point 125 between the wedge shaped element 111 and the link arm 105 is provided with a pin 142 which, in the unlocked position of the handle 102, engages at the position 143 of the cut-out 141, and which, in the locked position of the handle 102, engages at the position 144 of the cut-out 141, see FIG. 16. During rotation of the handle, the wall parts of the housing 101 surrounding the cut-out 141, especially the tabs 145, 146, flex elastically in order to permit passage of the pin 142. Thereby, a suitable click-feeling is provided to the user when rotating the handle.

As can be seen from FIG. 6, the handle 102 has the wedge shaped recess 110 which is engaged with the correspondingly shaped wedge shaped element 111 which is pivotably arranged in the housing 101 about the pivot point 126. When the handle is engaged with the wedge shaped element 111, a pin 112 is pressed through an opening in the handle and the wedge shaped element. This holds the handle firmly attached to the wedge shaped element. By removing the pin, the handle can be removed from the locking device 7 and exchanged with another handle. Washers 113 are arranged on either side of the wedge shaped element. The washers are made from a relatively soft material so that there will be a certain amount of friction between the housing and the handle. This will give a better feel to the movement of the handle. This better movement will give a feeling of good quality to the user.

As can be seen from FIG. 7, the locking device 7 is arranged to be attached to the sash element by first inserting the housing of the locking device through a hole in the sash element from below the sash element and then inserting the handle, from the top of the sash element, into an actuation opening 114 in a face 136 of the sash member, said face 136 of the sash member being substantially at right angles to the window pane or door leaf. Once the handle 102 is in place, a pin 112 is inserted through a circular engagement portion 133 of the handle 102 which holds the handle firmly on the housing. The pin 112 extends tangentially in the circular engagement portion 133. In this way, it is possible to later on change the handle if desired.

It should be noted, that when the handle is rotated to the closed position, the pin is not visible and cannot be removed, as its outward end is rotated with the handle to a position inside the housing 101. Due to this, if the handle is to be removed, it must first be rotated to the open position of the locking device. The housing 101 comprises two opposed side walls 137 that extend through the actuation opening 114 in the face 136 of the sash member and cover the circular engagement portion 133 of the handle 102, and the wedge shaped element 111 is pivotably mounted in the two opposed side walls 137.

FIGS. 8 to 10 show details of the centre striking plate 11 of the locking device. As can be seen from the figures the striking plate comprises a first flange 120 and a second flange 121 which are arranged at an angle to each other. The second flange is mounted to an outwardly facing surface 25 of the frame member 2 and the second flange comprises L-shaped 122 recesses for fastening on to the mushroom cams 9 of the locking device. Since the locking device is arranged to displace the mushroom cams outwardly when locked, the striking plate 11 is formed with two L shaped recesses 122 where the L's are arranged back to back, such that the base portions of the L's point away from each other. The advantage of having two mushroom cams which move away from each other in the closed position, is that the strength of the window or door assembly against break in is increased. When trying to force one mushroom cam away from the striking plate, the other mushroom cam will be pressed more in to the striking plate. It can also be seen that due to the arrangement of the striking plate, in the case where the window or door assembly is attempted to be forced open, the striking plate will bend such that it is even more locked. Also, the forces which are applied when attempting to force the window or door open are arranged such that the striking plate is exposed to tensile forces arranged in a direction in which the striking plate is very strong. The forces are transferred directly back to the frame member. In this way, the locking device is very strong. A slightly modified embodiment of the centre striking plate 11 is shown in FIG. 25. In fact, in this embodiment, the outer part of the flange 120 has been cut off when compared to the embodiment shown in FIGS. 8 to 10. This may especially be advantageous in a slim frame and sash construction.

The corner striking plate 10 shown in FIG. 11 is arranged at the corner of the window or door assembly. As with the corner hinges, the corner striking plate is also attached to both frame members at the corner via screws (not shown). This again increases the strength of the joint and allows the forces applied to the corner striking plate to be split between the two frame members. The corner striking plate is also arranged such that if force is applied during a break in attempt, the corner striking plate will bend about the line 123 which connects the two mounting screws and the corner striking plate will bend into an even more locked position.

It should be noted that in both the centre striking plate 11 and the corner striking plate 10 shown in FIGS. 8 to 11, only a single locking position is provided for. However, in the embodiment shown in FIGS. 12 to 15 and 19 to 22, the corner striking plates 10 are provided with two recesses 134a, 134b, and the espagnolette bolts 8 are split up into two end bolts 135a, 135b at their outer end. In this way the window or door can be locked in a slightly open position or it can be locked in a fully closed position. In the slightly open position, the end bolt 135b will engage the recess 134a, see FIGS. 20 and 21. In the fully closed position, the end bolt 135a engages the recess 134a the end bolt 135b engages the recess 134b. The end bolt 135a could be omitted, however, especially in a slim frame and sash construction, a better strength of the espagnolette mechanism may be obtained with two end bolts.

1. An outwardly opening window or door assembly (1) comprising a sash (3) carrying a window pane (4) or door leaf and being mounted in a frame (2) movable between an open position and a closed position, a locking device (7) comprising a housing (101) being mounted in a cavity of a sash member of the sash, the locking device (7) comprising at least one displaceable locking element (8, 9) adapted to engage a striking plate (10, 11) mounted on the frame (2) and a handle (102) adapted to displace the locking element (8, 9) between a locked position and an unlocked position, the handle (102) protruding through an actuation opening (114) in a face (136) of the sash member, said face (136) of the sash member being substantially at right angles to the window pane (4) or door leaf, characterized in that the handle (102) is provided with an at least partially circular engagement portion (133) extending through the actuation opening (144) in the face of the sash member, and in that the at least partially circular engagement portion (133) is provided with a wedge shaped recess (110) that is releasably engaged with a correspondingly shaped wedge shaped element (111) pivotably arranged in the housing (101).

2. An outwardly opening window or door assembly according to claim 1, characterized in that the wedge shaped element (111) is pivotably arranged about an axis located near said face (136) of the sash member being substantially at right angles to the window pane (4) or door leaf.

3. An outwardly opening window or door assembly according to claim 1, characterized in that the at least partially circular engagement portion (133) is releasably engaged with the wedge shaped element (111) by means of a pin (112) extending tangentially in the at least partially circular engagement portion (133).

4. An outwardly opening window or door assembly according to claim 3, characterized in that the pin (122) is accessible from outside the sash member, when the handle (102) is in the unlocked position.

5. An outwardly opening window or door assembly according to claim 1, characterized in that the housing (101) comprises two opposed side walls (137) that extend through the actuation opening (114) in the face (136) of the sash member and cover the at least partially circular engagement portion (133) of the handle (102), and in that the wedge shaped element (111) is pivotably mounted in the two opposed side walls (137) that extend through the actuation opening (114).

6. An outwardly opening window or door assembly according to claim 1, characterized in that the wedge shaped element (111) is pivotably connected to a link arm (105) that is pivotably connected to a first displaceable element (103) that is arranged displaceably in the housing (101) in the longitudinal direction of the sash member and carries a first locking element (8, 9), and in that the pivot point (125) between the wedge shaped element (111) and the link arm (105), in the locked position of the handle (102), is arranged on the opposite side of the line (132) that connects the pivot point (126) between the wedge shaped element (111) and the housing (101) and the pivot point (124) between the link arm (105) and the first displaceable element (103) when compared to the position of the pivot point (125) between the wedge shaped element (111) and the link arm (105) in the unlocked position of the handle (102).

7. An outwardly opening window or door assembly according to claim 1, characterized in that a second displaceable element (104) is arranged displaceably in the housing (101) in the longitudinal direction of the sash member and carries a second locking element (8, 9), and in that a gear in the form of a pivotable element (106) with two arms (127, 128) protruding from a center pivot (129) is arranged such that a first (127) of the two arms is placed in a recess (130) in the first displaceable element (103) and a second (128) of the two arms is placed in a recess (131) in the second displaceable element (104).

8. An outwardly opening window or door assembly according to claim 7, characterized in that the second (128) of the two arms is longer than the first (127) of the two arms.

9. An outwardly opening window or door assembly according to claim 6, characterized in that the first and the second displaceable elements (103, 104) are provided with locking elements in the form of a first and a second mushroom cam (9a, 9b), respectively, for engagement with a center striking plate (11) mounted on a frame member extending along the sash member comprising the locking device (7).

10. An outwardly opening window or door assembly according to claim 6, characterized in that the first and the second displaceable elements (103, 104) are provided with locking elements in the form of first and second espagnolette bolts (8a, 8b), respectively, extending along an outer edge of the sash member that comprises the locking device (7) and being arranged for engagement with corner striking plates (10) mounted at corners of the frame (2).

11. An outwardly opening window or door assembly according to claim 10, characterized in that the first and second espagnolette bolts (8a, 8b) have a rectangular shape with one dimension being larger than the other dimension, so that the larger dimension is arranged perpendicular to a general plane of the window pane (4) or door leaf

12. An outwardly opening window or door assembly according to claim 10, characterized in that each of the first and second espagnolette bolts (8a, 8b) has an engagement portion adapted to engage a respective corner striking plate (10), wherein the engagement portion is split up into two separate end bolts (135a, 135b) spaced in a direction perpendicular to the general plane of the window pane (4) or door leaf.

13. An outwardly opening window or door assembly according to claim 9, characterized in that a center striking plate (11) comprises a first flange (120) and a second flange (121) which are arranged at an angle to each other, in that the second flange (121) is mounted to an outwardly facing surface of a frame member extending along the sash member comprising the locking device (7), and in that the first flange (120) comprises L-shaped recesses (122) for engagement with the mushroom cams (9) of the locking device (7).

14. An outwardly opening window or door assembly according to claim 10, characterized in that first and second corner striking plates (10) are arranged at the corners of the frame corresponding to the first and second espagnolette bolts (8a, 8b), respectively, and in that each corner striking plate (10) comprises a first flange (138) having a recess (139) for engagement with the respective espagnolette bolt (8) and a second flange (140) being mounted to an outwardly facing surface of both frame members at the respective corner.
